(19) United States
(12) Patent Application Publication
(10) Pub. No.: US 2010/0265652 A1
(43) Pub. Date: Oct. 21, 2010

(54) Docking Device for Portable Computers

(76) Inventors: Hiroaki Agata, Yokohama-shi (JP); Eiji Shinohara, Kawasaki-shi (JP); Fumio Tamura, Tokyo (JP); Mitsuo Horiuchi, Sagamihara-shi (JP)

Correspondence Address: DILLON & YUDELL LLP, 8911 N. CAPITAL OF TEXAS HWY, SUITE 2110, AUSTIN, TX, 78759, US

(21) Appl. No.: 12/725,501

(22) Filed: Mar. 17, 2010

(30) Foreign Application Priority Data
Apr. 17, 2009 (JP) 2009-101327

(51) Int. Cl. G06F 1/16

(52) U.S. Cl. 361/679.41

(57) ABSTRACT

A docking device for portable computers is disclosed. The docking device includes a casing, a connector affixed to the casing, and a support member arranged on the casing. The support member is capable of being moved up and down via an elastic member disposed therebetween.

### PRIORITY CLAIM

The present application claims benefit of priority under 35 U.S.C. §§120, 365 to the previously filed Japanese Patent Application No. JP2009-101327 entitled, “Docketing Device” with a priority date of Apr. 17, 2009, which is incorporated by reference herein.

### BACKGROUND

1. Technical Field

The present invention relates to a docking device for portable computers in general, and in particular to a docking device that electrically connects to a portable computer for extending functions of the portable computer.

2. Description of Related Art

In recent years, portable personal computers or laptop personal computers (laptop PCs) having small sizes and light weight have become widely popular. A docking device is a device for extending the functions of laptop PCs without impairing the portability of the laptop PCs.

FIG. 15 is a perspective view of a docking device 40. FIG. 16 shows a side view of the docking device 40, and a laptop PC 50 to be connected to the docking device 40. The docking device 40 shown in FIG. 15 has an upper surface portion 43 for mounting the laptop PC 50 thereon, and a connector 41 is provided in the vicinity of the center of the upper surface portion 43. Moreover, a hook member 42 is provided on both sides of the connector 41. On the other hand, as shown in FIG. 16, the laptop PC 50 has a bottom surface 52 in which a connector 51 connected to the connector 41 of the docking device 40 and engagement holes (not shown) for achieving engagement with the hook members 42 of the docking device 40 are formed.

In such a state as shown in FIG. 16, by mounting the laptop PC 50 on the upper surface 43 of the docking device 40 and connecting the connector 51 on the side of the laptop PC 50 to the connector 41 on the side of the docking device 40, it is possible to use the functions of the docking device 40 as the functions of the laptop PC 50, thus extending the functions of the laptop PC 50. Moreover, by engaging the hook members 42 of the docking device 40 with the engagement holes (not shown) of the laptop PC 50, a state is maintained where the laptop PC 50 is mechanically coupled with the docking device 40.

However, the bottom surface 52 of the laptop PC 50 is not always perfectly flat, but there may be some warping (bending) due to the influence of a dimensional errors during manufacturing or temperature. For example, as shown in FIG. 17, a warping may occur in such a way that both the left and right sides of the bottom surface 52 of the laptop PC 50 bend downwards relative to the central portion, and as a result, the bottom surface 52 has a concave shape. In such a case, when the laptop PC 50 is docked with the docking device 40, both the left and right-end portions of the bottom surface 52 come into contact with the upper surface 43 of the docking device 40. Therefore, it is difficult to securely connect the connector 41 on the docking device 40 to the connector 51 on the laptop PC 50. Moreover, it is difficult to engage the hook members 42 with the engagement portions of the laptop PC 50.

On the other hand, as shown in FIG. 18, a warping may occur in such a way that both the left and right sides of the bottom surface 52 of the laptop PC 50 bend upwards relative to the central portion, and as a result, the bottom surface 52 has a convex shape. In such a case, it is possible to connect the connector 41 on the docking device 40 to the connector 51 on the laptop PC 50. Moreover, it is possible to engage the hook members 42 with the engagement portions of the laptop PC 50. However, in this case, since a gap is formed between both the left and right sides of the bottom surface 52 of the laptop PC 50 and the upper surface 43 of the docking device 40, the laptop PC 50 becomes unstable and rattles loosely.

Consequently, it would be desirable to obviate the above-described problems encountered by the conventional docking device and to provide a docking device that is capable of securely connecting to a laptop PC.

### SUMMARY

In accordance with a preferred embodiment of the present invention, a docking device includes a casing, a connector affixed to the casing, and a support member arranged on the casing. The support member is capable of being moved up and down via an elastic member disposed therebetween.

All features and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is a perspective view showing a docking device and a laptop PC according to the present embodiment;

FIG. 2 is a diagram showing the docking device and the laptop PC from FIG. 1;

FIG. 3 is an exploded perspective view of the docking device from FIG. 1;

FIG. 4 is a perspective view of the docking device from FIG. 1 in the undock state;

FIG. 5 is a top view of FIG. 4;

FIG. 6 is a cross-sectional view along the line A-A in FIG. 5;

FIG. 7 is a diagram showing the docking device and the laptop PC from FIG. 1 in the dock state;

FIG. 8 is a perspective view of the docking device from FIG. 1 in the dock state;

FIG. 9 is a cross-sectional view of the docking device from FIG. 8;

FIG. 10 is a diagram of the dock state when a warping occurs in a bottom surface of the laptop PC;

FIG. 11 is a perspective view of the docking device in the state shown in FIG. 10;

FIG. 12 is a cross-sectional view along the line B-B in FIG. 11;

FIG. 13 is a diagram illustrating the dock state when a warping occurs in a bottom surface of the laptop PC;

FIG. 14 is a diagram showing an example of a lock mechanism;

FIG. 15 is a perspective view of a conventional docking device;

FIG. 16 is a diagram showing the docking device from FIG. 15 and a laptop PC to be connected to the docking device;

FIG. 17 is a diagram showing the docking device from FIG. 15 and a laptop PC connected to the docking device; and

FIG. 18 is a diagram showing the docking device from FIG. 15 and a laptop PC connected to the docking device.

### DETAILED DESCRIPTION OF A PREFERRED EMBODIMENT

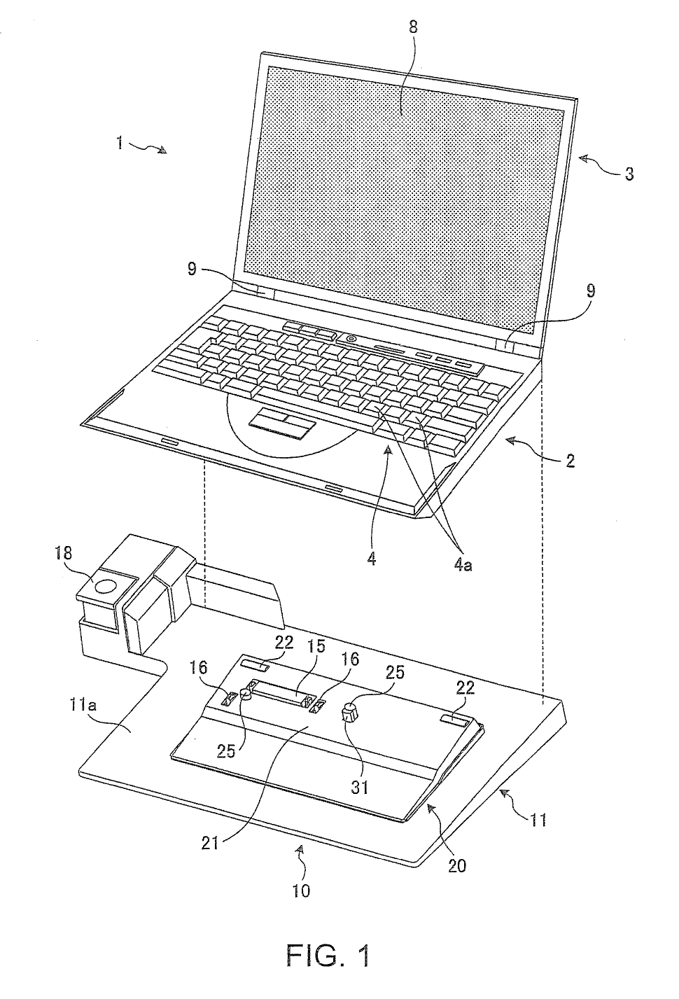

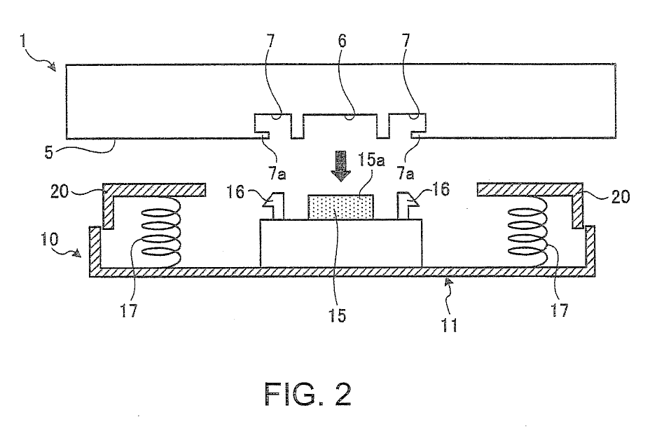

FIG. 1 is a perspective view showing a laptop PC 1 and a docking device 10 to be connected to the laptop PC 1. FIG. 2 is a side view of the laptop PC 1 and the docking device 10 shown in FIG. 1. In FIG. 2, the arrangement of hook members 16 of the docking device 10 is shown differently from that in FIG. 1 for convenience sake. The laptop PC 1 shown in FIG. 1 includes a body casing 2 and a cover body 3. The body casing 2 is a box-like structure that accommodates therein constituent components (not shown) such as a processor and a memory device. On an upper surface of the body casing 2, a keyboard 4 configured by arranging multiple key tops 4a.

Moreover, on a bottom surface 5 of the body casing 2, there are provided a PC-side connector 6 (see FIG. 2) that is configured to be connected to a docking device-side connector 15 described later, engagement holes 7 (see FIG. 2) for achieving engagement with hook member 16 provided in the docking device 10, and concave positioning portions (not shown) for inserting convex positioning portions 25 provided in the docking device 10 thereto. As shown in FIG. 2, the PC-side connector 6 has a concave connection portion and is provided at an approximately central position on an inner side of the bottom surface 5 of the laptop PC 1.

The cover body 3 is a box-like structure that accommodates a display device 8 such as a liquid crystal display (LCD). As shown in FIG. 1, the cover body 3 is supported so that a base end portion thereof is pivoted by hinge portions 9 that are provided at an inner edge portion of the body casing 2. When the cover body 3 is opened relative to the body casing 2, the display device 8 is exposed towards the front side of the body casing 2, and the upper surface of the body casing 2 is open. On the other hand, when the cover body 3 is pivoted by the hinge portions 9, the cover body 3 functions as a cover that covers the upper surface of the body casing 2 and the display device 8 together.

The docking device 10 is a device that mounts the laptop PC 1 on an upper surface 11a thereof and connects it to the laptop PC 1, thus extending the functions of the laptop PC 1. The docking device 10 is also referred to as “docking station,” “port replicator,” or “function extending device.” Here, a state where the docking device 10 is connected to the laptop PC 1 refers to a state where the PC-side connector 6 is electrically connected to the docking device-side connector 16, and at the same time, the hook members 16 provided in the docking device 10 are engaged with the engagement holes 7 of the laptop PC 1, whereby a state where the laptop PC 1 is mechanically coupled with the docking device 10 is maintained. In the description below, a state where the docking device 10 is connected to the laptop PC 1 will be referred to as “dock state,” and a state where the docking device 10 is not connected to the laptop PC 1 will be referred to as “undock state.” In addition, for the sake of convenience, when a user uses the laptop PC 1 by docking it with the docking device 10, the side closest to a user will be referred to as “front side” of the docking device 10, and the opposite side will be referred to as “rear side,” and the left and right sides as viewed from the user will be referred to as “left side” and “right side” of the docking device 10, respectively.

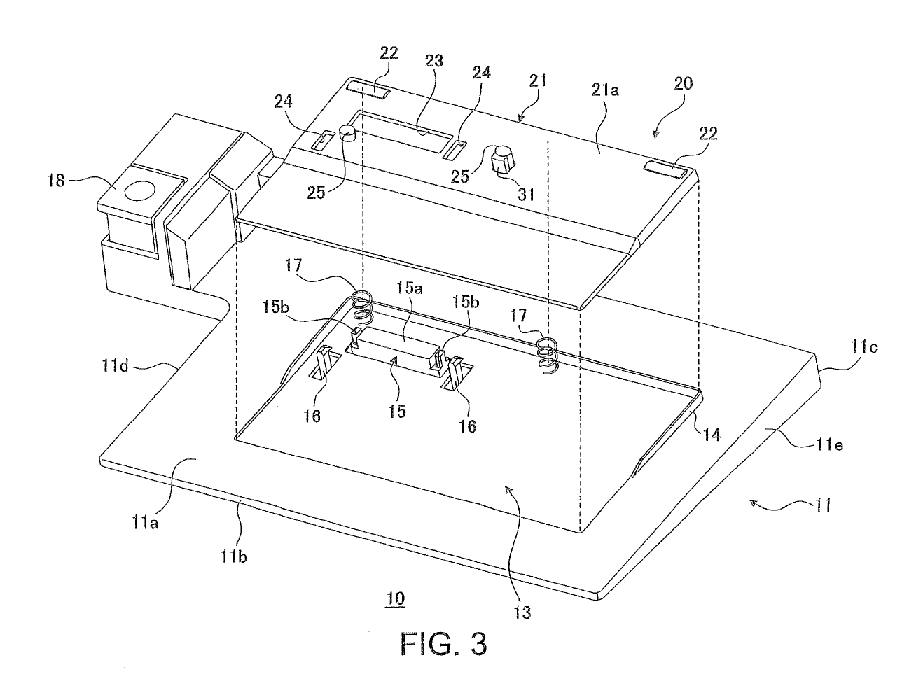

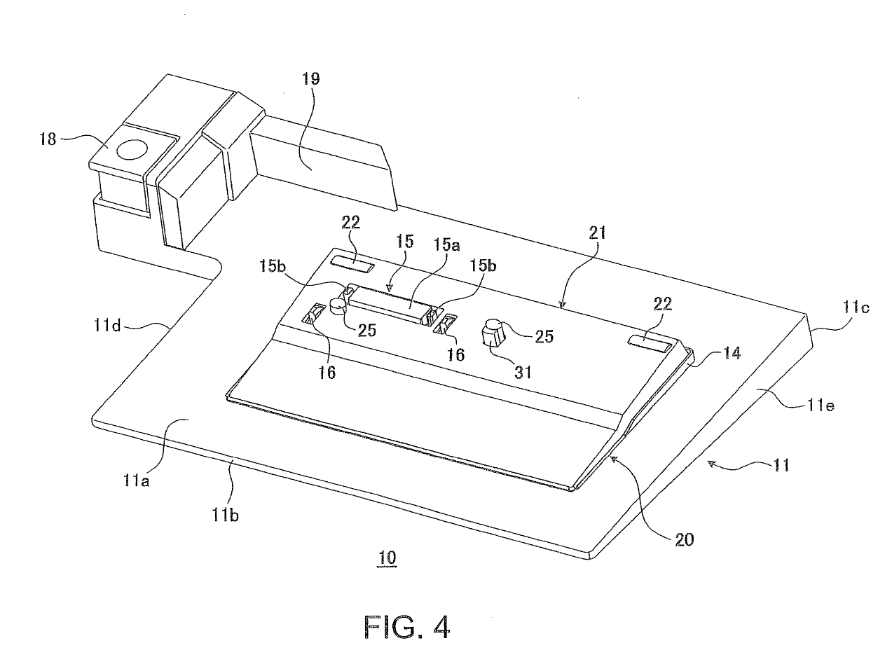

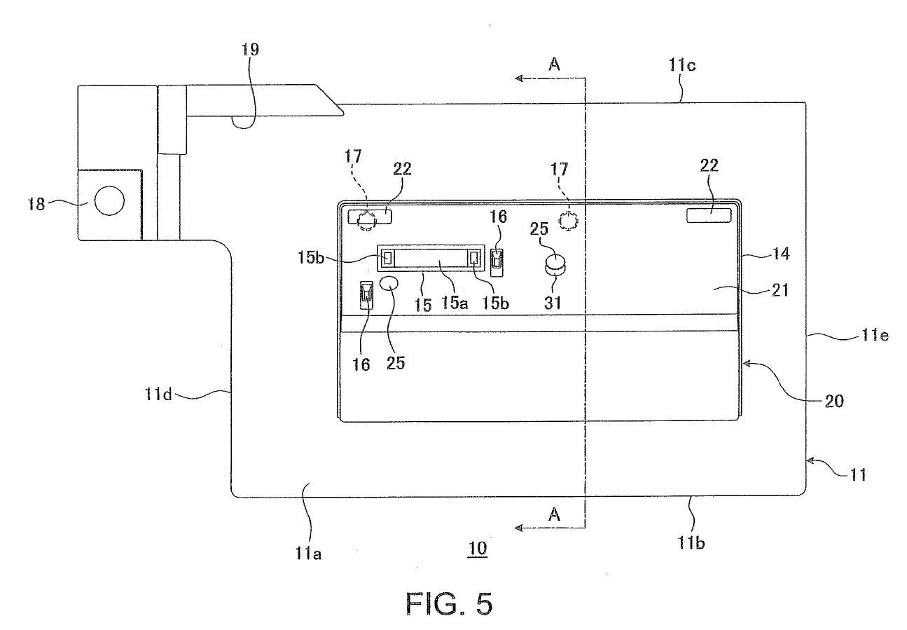

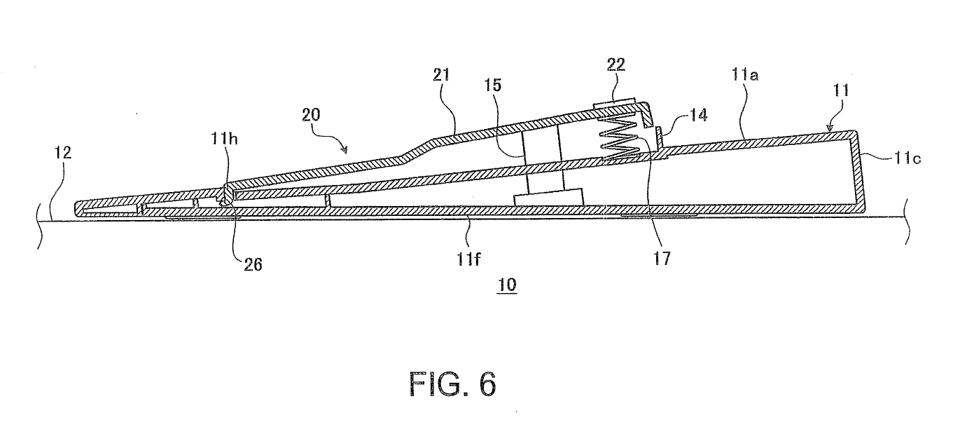

FIG. 3 is an exploded perspective view of the docking device 10 shown in FIG. 1, FIG. 4 is a perspective view showing the docking device 10 in the undock state, FIG. 5 is a top plan view of FIG. 4, and FIG. 6 is a cross-sectional view along the A-A line in FIG. 5. In FIG. 6, only elastic members 17 and the docking device-side connector 15 are shown as the components accommodated in the docking device 10, and other components are omitted.

As shown in FIG. 3, the docking device 10 includes a casing 11 and a support member 20 that is provided on the casing 11 with elastic members 17 disposed therebetween.

As shown in FIG. 3, the casing 11 is a thin box-like structure configured by a thin board made of material such as metal or synthetic resin. The casing 11 is constituted by an upper surface portion 11a on which the bottom surface 5 of the laptop PC 1 is mounted when the docking device 10 is in the dock state, a front surface portion 11b that is a front side surface, a back surface portion 11c that is an inner side surface, a left side surface portion 11d that is a left side surface, a right side surface portion 11e that is a right side surface, and a bottom surface portion 11f (see FIG. 6) that opposes a mounting surface 12 such as a table. The upper surface portion 11a has an approximately rectangular shape as shown in FIG. 5 and is inclined downward towards the front side so that a height dimension from the mounting surface 12 of the case 11 decreases gradually from the rear side to the front side. This is to provide improved operability of the keyboard 4 when the user uses the keyboard 4 in a state where the laptop PC 1 is docked on the upper surface portion 11a.

On the back surface portion 11c and the right side surface portion 11e of the casing 11, connection terminals (not shown) such as serial or parallel ports or USB ports for connecting it to various external peripheral devices and extension slots (not shown) such as PCI buses are arranged. Moreover, the casing 11 accommodates therein a power supply unit (not shown) for driving the docking device 10 with power supplied from a commercial power source, a control circuit (not shown) connected to the above-described connection terminals provided on the back surface portion 11c and the right side surface portion 11e, and a drive unit (not shown) such as a CD-ROM drive or a DVD drive.

The upper surface portion 11a of the casing 11 is formed with the same size as a bottom surface area of the laptop PC 1 having a typical size, and a support member mounting area 13 is provided at the center of the upper surface portion 11a as shown in FIG. 3. The support member mounting area 13 is a rectangular area on which a support member 20 described later is mounted, and a guide wall 14 is provided along a rear peripheral portion of the support member mounting area 13 so as to guide a vertical movement of a movable board described later. Within the support member mounting area 13, the docking device-side connector 15, a pair of hook members 16 and 16 disposed on both the left and right sides of the docking device-side connector 15, a pair of elastic members 17 disposed on a backward side of the docking device-side connector 15, and a dock-release button (not shown) are provided.

The docking device-side connector 15 includes a rectangular parallel piped fitting portion 15a having electrical terminals arranged therein and guide pins 15b and 15b attached at both the left and right sides of the fitting portion 15a. The docking device-side connector 15 is mounted on a control circuit which is accommodated in the casing 11 and is fixed to the casing 11 in a state where the fitting portion 15a is projected from the upper surface portion 11a of the casing 11. The guide pins 15b enable users to perform positioning properly to easily connect the PC-side connector 6 to the docking device-side connector 15 and are inserted into holes (not shown) formed in the bottom surface 5 of the laptop PC 1 at the time of positioning. When the fitting portion 15a of the docking device-side connector 15 is fitted to the PC-side connector 6, the docking device 10 and the laptop PC 1 are electrically connected together, whereby users are able to use the functions of the docking device 10 as the functions of the laptop PC 1.

The hook members 16 are configured to be movable in the front and rear direction of the docking device 10 and are provided so as to protrude outward from the upper surface portion 11a in a state of being urged backward by a spring not shown. The hook members 16 have distal ends which are configured as sloped surfaces inclined downward towards the rear side. When the laptop PC 1 is mounted on the docking device 10, engagement portions 7a of the laptop PC 1 are brought into abutting contact with the sloped surfaces of the hook members 16 from the sate shown in FIG. 2. With this operation, the hook members 16 are moved forward while resisting against an elastic force of the spring, and thereafter, the hook members 16 return to their original backward positions by the elastic force of the spring, whereby the hook members 16 are engaged with the engagement portions 7a. In this way, the laptop PC 1 is mounted on the docking device 10, and a state where the laptop PC 1 is mechanically connected to the upper surface portion 11a of the docking device 10 is maintained.

Moreover, when the laptop PC 1 is separated from the docking device 10, by pressing an eject button 18, the hook members 16 are moved forward by means of a link mechanism not shown, and the dock-release button (not shown) is projected from the upper surface 11a. In this way, the engagement between the hook members 16 and the engagement portions 7a of the laptop PC 1 is released, and the bottom surface 5 of the laptop PC 1 is pushed upward by the dock-release button, whereby the laptop PC 1 can be removed from the docking device 10.

The elastic members 17 are configured by a pair of coil springs and are disposed in the support member mounting area 13 at backward positions of the docking device-side connector 15 with a predetermined spacing therebetween. The pair of elastic members 17 are inserted between the upper surface 11a of the casing 11 and the support member 20 described later, thus supporting the rear end portion of the support member 20 so as to be movable in the up and down direction. In the present embodiment, although coil springs as shown in FIG. 2 are used as the elastic members 17, the elastic members are not limited to this, but other elastic members such as a plate spring, a dish spring or a rubber member may be used.

Next, detailed description of the support member 20 will be provided. The support member 20 is configured to include a plate-like movable board 21 which is configured by a thin board made of material such as metal or synthetic resin and abutting portions 22 that are provided on the movable board 21.

The movable board 21 is mounted on the support member mounting area 13 of the casing 11 with the elastic members 17 disposed therebetween so as to be movable in the up and down direction and supports the laptop PC 1 in a state of urging the bottom surface 5 of the laptop PC 1 in the dock state. The abutting portions 22 are provided to protrude from the upper surface of the movable board 11, and are portions with which the bottom surface 5 of the laptop PC 1 comes into abutting contact and which are configured by a shock-absorbing member such as rubber. The abutting portions 22 are provided at two locations, namely both the left and right end portions on the rear side of the movable board 20.

On the upper surface portion 21a of the movable board 21, in addition to the abutting portions 22, a connector insertion hole 23, hook member-insertion holes 24, positioning projections 25, a lock-release button 31, and a dock-release button-insertion hole (not shown) are provided. The connector insertion hole 23 is a hole for allowing the docking device-side connector 15 to be inserted therethrough. The hook member-insertion holes 24 are holes, respectively, for allowing the pair of hook members 16 to be inserted therethrough. The positioning projections 25 are projections that guide concave positioning portions (not shown) provided in the bottom surface portion 5 of the laptop PC 1 to achieve positioning of the laptop PC 1 when the laptop PC 1 is docked with the docking device 10; the projections are provided at two locations on the upper surface portion 21a. The lock-release button 31 is a button that releases a lock state of a lock mechanism restricting the vertical movement of the movable board 21 and is attached to the movable board 21 so as to be movable up and down relative to the movable board 21. Description of the function of the lock-release button 31 and the lock mechanism will be provided later. The dock-release button-insertion hole is a hole for allowing the dock-release button to be inserted therethrough.

As shown in FIGS. 3 and 4, the movable board 21 is disposed on the support member mounting area 13 in a state where the docking device-side connector 15 is inserted through the connector insertion hole 23, the hook members 16 are inserted through the hook member-insertion holes 24, and the elastic members 17 are disposed therebetween. As shown in FIG. 6, an engagement portion 26 is provided at a front end of the movable board 21, and the engagement portion 26 is engaged with an engagement hole 11h that is formed in the upper surface portion 11a of the casing 11. The movable board 21 having such a configuration is provided such that a rear end side thereof is movable (pivoted) up and down by the elastic force of the elastic members 17 about the engagement portion 26 at the front end thereof.

As shown in FIG. 6, in the undock state, the elastic members 17 are held substantially in their natural length state. As shown in FIG. 6, in the undock state, it is preferable that the upper surface of the docking device-side connector 15 is positioned to be lower than the upper surface of the movable board 21 or to be even with the upper surface of the movable board 21.

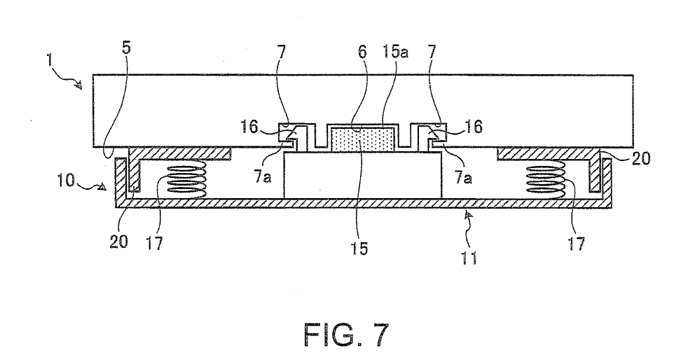

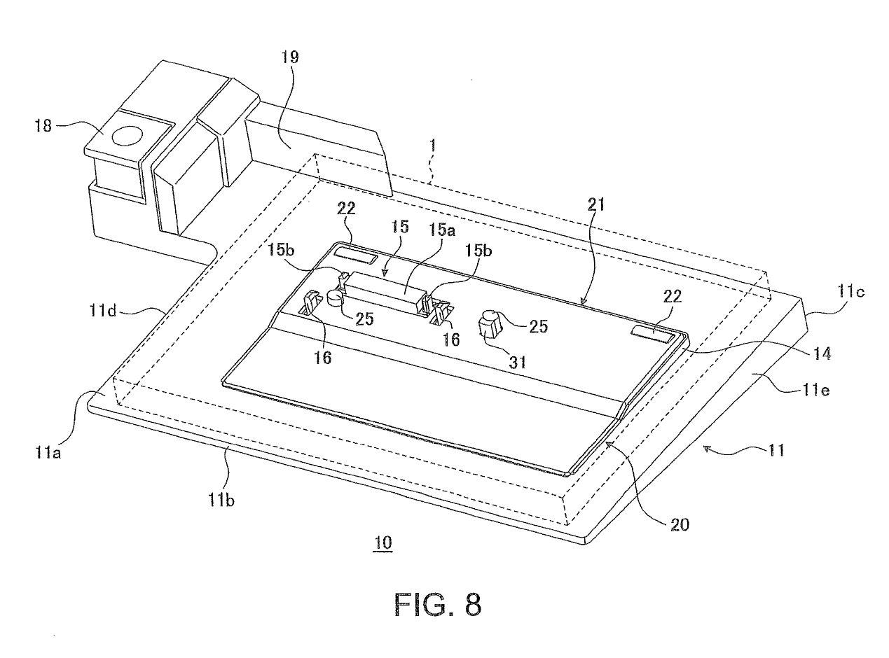

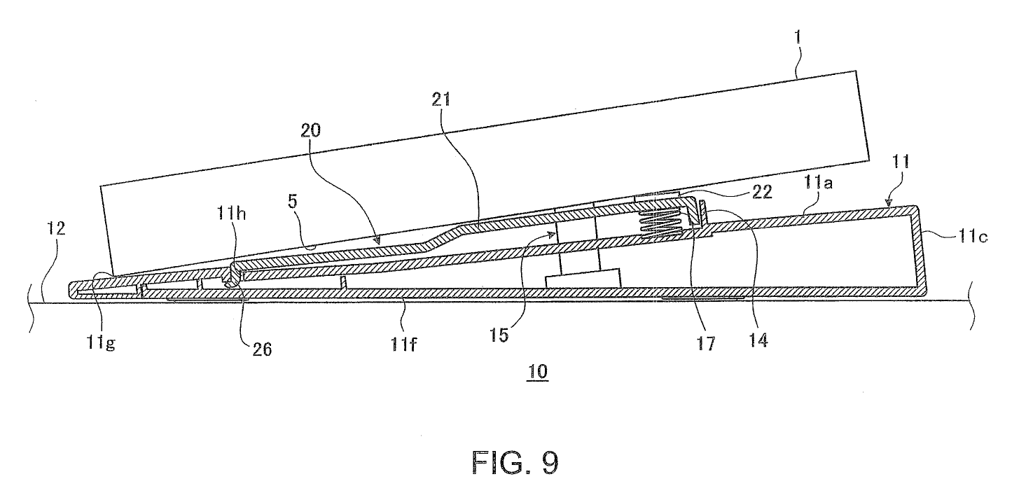

Next, description of the state (dock state) where the laptop PC 1 is docked on the docking device 10 will be provided. FIG. 7 is a diagram illustrating the dock state. FIG. 8 is a perspective view of the docking device 10 in the dock state, and FIG. 9 is a cross-sectional view of FIG. 8. Here, FIG. 9 is taken along the same line as the line A-A in FIG. 5.

FIG. 7 shows the dock state when there is no warping in the bottom surface 5 of the laptop PC 1. When the laptop PC 1 is moved downward from the state shown in FIG. 2, the support member 20 is downwardly pressed by the bottom surface 5 of the laptop PC 1, whereby the fitting portion 15a of the docking device-side connector 15 is fitted to the PC-side connector 6. At the same time, the hook members 16 of the docking device 10 are engaged with the engagement portions 7a of the laptop PC 1. Moreover, in the state shown in FIG. 7, the laptop PC 1 is supported by the support member 20 in a state where the bottom surface 5 is urged by the elastic members 17. For this reason, the laptop PC 1 can be supported in a stable state without rattling loosely.

Detailed description of the dock state shown in FIG. 7 is provided with reference to FIGS. 8 and 9. When the laptop PC 1 is docked with the docking device 10, a left side of the bottom surface of the laptop PC 1 is first brought into abutting contact with the positioning wall portion 19 on the casing 11 of the docking device 10, thus achieving a rough positioning. From this state, the convex positioning portions 25 of the docking device 10 are inserted into the concave positioning portions (not shown) of the laptop PC 1, and the guide pins 15b of the docking device-side connector 15 are inserted into the guide holes (not shown) of the laptop PC 1, whereby the PC-side connector 6 is guided to a proper connection position. In this way, as shown in FIGS. 8 and 9, the movable board 21 of the support member 20 is downwardly pressed by the laptop PC 1, and the whole body of the fitting portion 15a of the docking device-side connector 15 is projected outward from the upper surface portion 11a to be connected to the PC-side connector 6. At the same time, although not shown in FIG. 9, the hook members 16 of the docking device 10 are engaged with the engagement portions 7a of the laptop PC 1. As shown in FIG. 9, the laptop PC 1 makes abutting contact with the docking device 10 at three positions in total, the two positions with the abutting portions 22 of the support member 20 and one position with a front end portion 11g of the upper surface portion 11a of the casing 11. In this state, the laptop PC 1 is supported in a stable state since it is supported by the abutting portions 22 in a state where the bottom surface 5 is urged by the elastic members 17. Here, in FIG. 9, a front end portion of the bottom surface portion 5 of the laptop PC 1 makes abutting contact with the front end portion 11g of the upper surface portion 11a of the casing 11. However, when two rubber legs (not shown) are attached to each of the front and rear edges of the bottom surface 5 of the laptop PC 1, the two rubber legs on the front end side make abutting contact with the front end portion 11g of the upper surface portion 11a.

Moreover, in addition to the state shown in FIG. 9, for example, when the bottom surface area of the laptop PC 1 is greater than that shown in FIG. 9, the front end portion of the laptop PC 1 may be disposed in a state of protruding further forward than the upper surface portion 11a of the casing 11. In such a case, the front end portion of the bottom surface 5 of the laptop PC 1 will make abutting contact with the mounting surface 12 rather than the front end portion 11g of the casing 11 shown in FIG. 9. In addition, when the above-described rubber legs are attached to the bottom surface 5 of the laptop PC 1, the two rubber legs on the front end side will make abutting contact with the mounting surface 12.

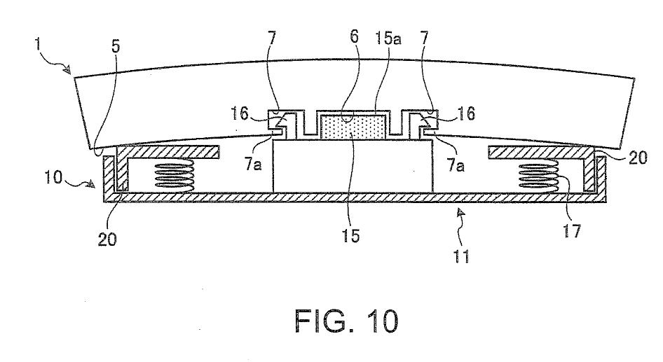

In the example shown in FIG. 7, although the case where the bottom surface 5 of the laptop PC 1 is flat has been described, a warping may occur in the bottom surface 5 of the laptop PC 1 due to the influence of dimensional errors during manufacturing or temperature. FIG. 10 is a conceptual diagram showing the dock state when a warping occurs in the bottom surface of the laptop PC. In the description below, a case will be described for a case where as shown in FIG. 10, a warping occurs in such a way that both the left and right sides of the bottom surface 5 of the laptop PC 1 bend downwards relative to the central portion, and the bottom surface 5 has a concave shape.

When the laptop PC 1 is moved downward from the state shown in FIG. 2, both the left and right side portions of the bottom surface 5 of the laptop PC 1 come into contact with the support member 20, whereby the support member 20 is pressed downward while resisting against the elastic force of the elastic members 17, as shown in FIG. 10. For this reason, unlike the conventional docking device, the downward movement of the PC-side connector 6 will not be restricted by both the left and right side portions of the bottom surface 5 of the laptop PC 1. As a result, the PC-side connector 6 can be lowered to the fitting portion 15a of the docking device-side connector 15, and thus the docking device-side connector 15 can be securely connected to the PC-side connector 6. At the same time, the engagement holes 7 of the laptop PC 1 can be lowered to positions where they can be engaged with the hook members 16 of the docking device 10, thus achieving engagement with the hook members 16. Furthermore, in the state shown in FIG. 10, since the laptop PC 1 is supported by the support member 20 in a state where the bottom surface 5 is urged by the elastic members 17, the laptop PC 1 can be supported in a stable state without rattling loosely on the docking device 10.

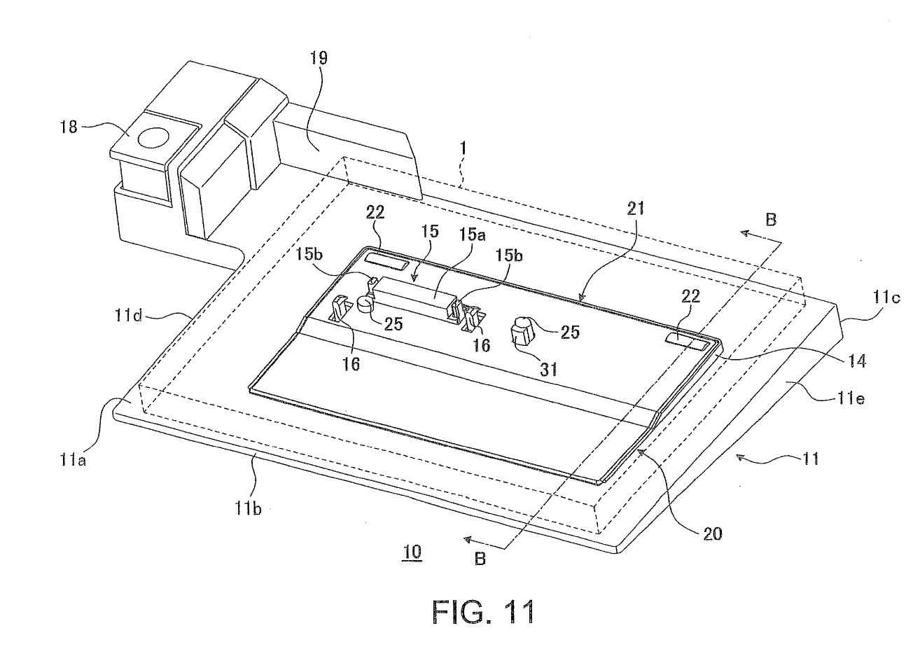

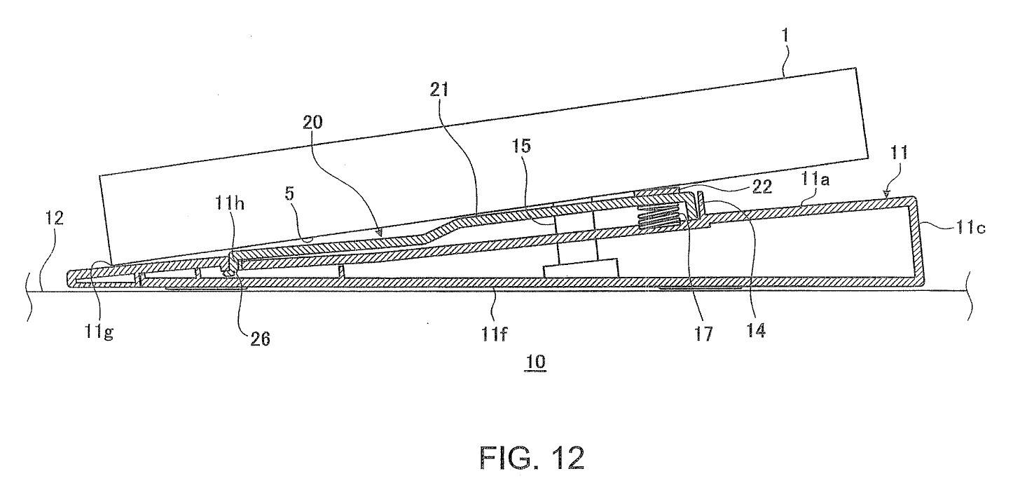

FIG. 11 is a perspective view of the docking device 10 in the dock state shown in FIG. 10, and FIG. 12 is a cross-sectional view along the line B-B in FIG. 11. In FIG. 12, only the elastic members 17 and the docking device-side connector 15 are shown as the components accommodated in the docking device 10, and other components are omitted. Detailed description of the dock state shown in FIG. 10 will be provided with reference to FIGS. 11 and 12. When the laptop PC 1 is docked with the docking device 10, by performing positioning as described above, the PC-side connector 6 is guided to a proper connection position. The movable board 21 is downwardly pressed by the laptop PC 1, and the whole body of the fitting portion 15a of the docking device-side connector 15 is projected outward from the upper surface portion 11a to be securely connected to the PC-side connector 6. Moreover, although not shown in FIG. 12, the hook members 16 of the docking device 10 are engaged with the engagement portions 7a of the laptop PC 1. Since the laptop PC 1 has a warping in such a way that the bottom surface 5 has a concave shape, as shown in FIG. 12, the movable board 21 is downwardly pressed more than that shown in FIG. 9. In the dock state shown in FIG. 12, the laptop PC 1 makes abutting contact with the docking device 10 at three positions in total, the two positions with the abutting portions 22 and one position with the front end portion 11g of the upper surface portion 11a of the casing 11. In this state, the laptop PC 1 is supported in a stable state since it is supported by the abutting portions 22 in a state where the bottom surface 5 is urged by the elastic members 17.

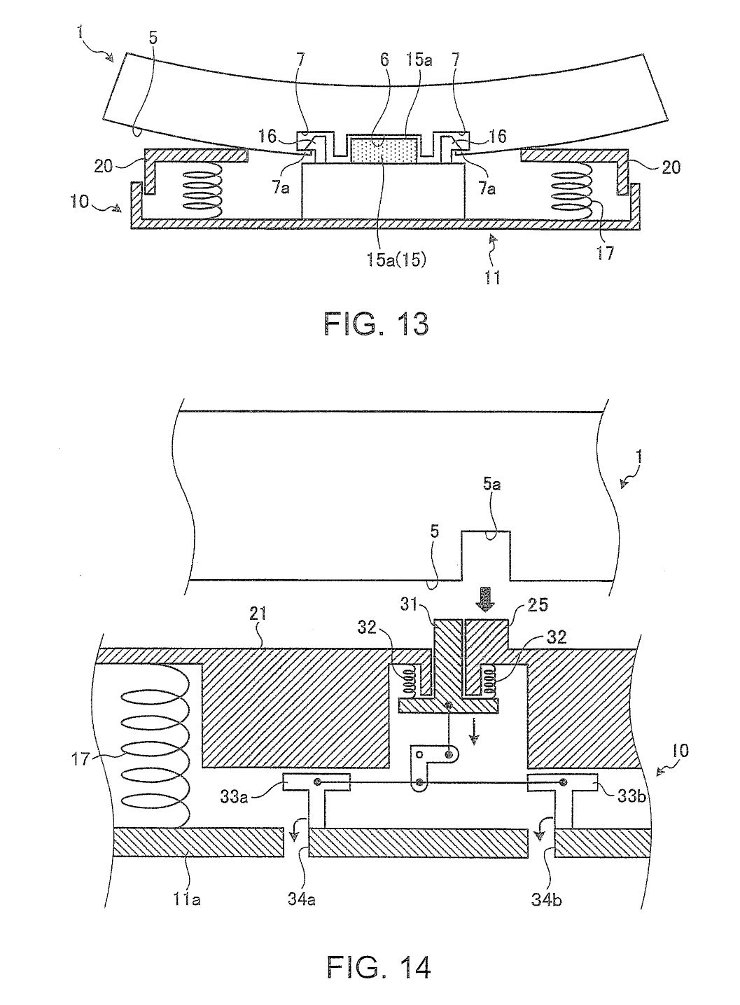

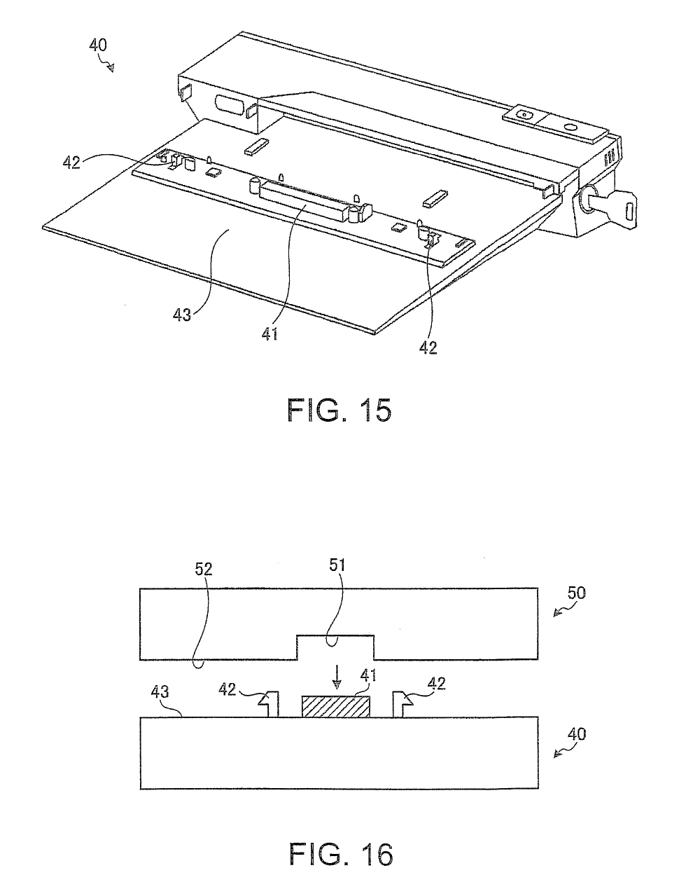

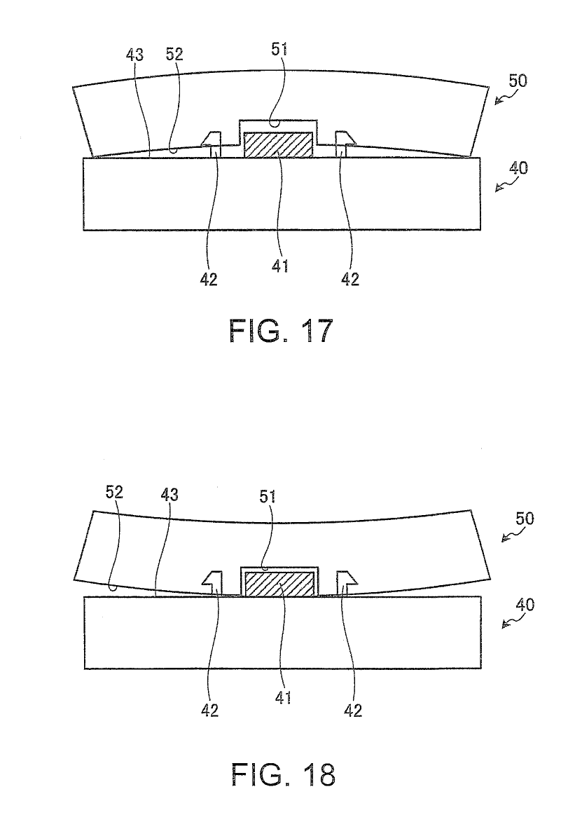

Contrary to the example shown in FIG. 10, a warping may occur in such a way that, as shown in FIG. 13, both the left and right sides of the bottom surface 5 of the laptop PC 1 bend upwards relative to the central portion, and the bottom surface 5 has a convex shape. In such a state, since neither of the left and right sides of the bottom surface 5 makes contact with the support member 20, the docking device-side connector 15 and the PC-side connector 6 can be securely connected together, and thus the hook members 16 of the docking device 10 can be securely engaged with the engagement portions 7a of the laptop PC 1. In addition, in this state, since the laptop PC 1 is supported by the support member 20 in a state where the bottom surface 5 is urged by the elastic members 17, the laptop PC 1 can be supported in a stable state without rattling loosely on the docking device 10 like the conventional configuration shown in FIG. 18.

Furthermore, if the docking device-side connector 15 is projected outward from the upper surface 11a when positioning of the laptop PC 1 is carried out above the docking device 10, there might occur an unfavorable state such that the bottom surface 5 of the laptop PC 1 collides with the docking device-side connector 15, thus destroying the docking device-side connector 15. In order to prevent the occurrence of such a state, in the present embodiment, a lock mechanism that restricts a vertical movement of the movable board 21 is provided so that the lock mechanism is released only when the laptop PC 1 is disposed at a proper position. FIG. 14 is a conceptual diagram of the lock mechanism. Hereinafter, an example of the lock mechanism will be described with reference to FIG. 14.

As shown in FIG. 14, the lock-release button 31 is attached to the movable board 21 so as to be movable up and down relative to the movable board 21 via a spring member 32. In the lock state shown in FIG. 14, the downward movement of the movable board 21 is restricted by restriction members 33a and 33b which are disposed between the movable board 21 and the upper surface 11a of the casing 11. Moreover, as described above, the upper surface of the docking device-side connector 15 is positioned to be lower than the upper surface 21a of the movable board 21 (see FIG. 6). That is to say, in this state, since the docking device-side connector 15 is not projected from the movable board 21, and the downward movement of the movable board 21 is restricted, the laptop PC 1 will not collide against the docking device-side connector 15 at the time of positioning, and thus the docking device-side connector 15 is protected.

From the state shown in FIG. 14, the laptop PC 1 is moved downward in order to achieve positioning of the laptop PC 1. When the convex positioning portions 25 of the movable board 21 are inserted into the concave positioning portions 5a of the laptop PC 1, the lock-release button 31 is downwardly pressed by the bottom surface 5 of the laptop PC 1. In conjunction with the downward movement of the lock-release button 31, the restriction members 33a and 33b are moved leftward in FIG. 14 to be inserted into holes 34a and 34b formed in the upper surface 11a of the casing 11. In this way, the lock mechanism is released, and the movable board 21 can be moved downward. Moreover, when the lock mechanism is released, the upper surface 21a of the movable board 21 can be pressed further downward than the fitting portion 15a of the docking device-side connector 15, and thus the connectors can be connected together. As described above, by configuring the lock mechanism to be released when the convex positioning portions 25 are inserted into the concave positioning portions 5a, it is possible to prevent the laptop PC 1 from colliding with the docking device-side connector 15 and thus breaking the docking device-side connector 15 at the time of achieving positioning of the laptop PC 1.

As has been described, the present invention provides a docking device having the support member 20 that is arranged on the casing 11 so as to be movable up and down via the elastic members 17 disposed therebetween. The docking device is configured such that in a state where the docking device is connected to the laptop PC 1, the docking device supports the laptop PC 1 by causing the bottom surface 5 of the laptop PC 1 to be urged by the support member 20. With such a configuration, even when a warping occurs in the bottom surface 5 of the laptop PC 1, the support member 20 is moved up and down depending on the degree of warping. Therefore, it is not only possible to securely connect the docking device-side connector 15 to the PC-side connector 6, but also to engage the hook members 16 of the docking device 10 with the engagement portions 7a of the laptop PC 1. Moreover, since the laptop PC 1 is supported in a state where the bottom surface 5 of the laptop PC 1 is urged by the support member 20, it is possible to support the laptop PC 1 in a stable state while preventing rattling of the laptop PC 1.

Moreover, according to the docking device of the present embodiment, the docking device includes the lock mechanism that restricts the vertical movement of the support member 20, and the lock mechanism is configured to be released only when the concave positioning portions 5a of the laptop PC 1 are guided to the convex positioning portions 25 of the docking device 10. Therefore, it is possible to prevent the laptop PC 1 from colliding with the docking device-side connector 15 and thus breaking the docking device-side connector 15 at the time of achieving positioning of the laptop PC 1.

The laptop PC 1 only needs to be supported in a state where the bottom surface 5 is urged by the abutting portions 22 by means of the elastic members 17 disposed therebetween, the arrangement, size, and shape of the movable board 21 and the arrangement position, size, and shape of the abutting portions 22 are not limited to the embodiment.

Also, as a mounting example of the movable board 21 relative to the upper surface 11a of the casing 11, the movable board 21 is configured such that the rear end side thereof is movable up and down by the elastic force of the elastic members 17 about the engagement portion 26 at the front end of the movable board 21. However, the elastic members 17 may be provided at two locations on the rear end side of the movable board 21 so that both the rear and front end sides of the movable board 21 are movable up and down by the elastic members 17.

Furthermore, the elastic members 17 are provided at two locations between the rear end side of the movable board 21 and the upper surface 11a of the casing 11. However, the number of elastic members 17 is not limited to two locations but may be one or three or more.

In addition, although the case has been described where the laptop personal computer is used as the portable information apparatus to be docked with the docking device 10, the docking device may be applied to other portable information apparatuses such as a Personal Digital Assistant (PDA).

While the invention has been particularly shown and described with reference to a preferred embodiment, it will be understood by those skilled in the art that various changes in form and detail may be made therein without departing from the spirit and scope of the invention.

What is claimed is:

1. A docking device comprising:
a casing;
a connector affixed to said casing; and
a support member arranged on said casing, wherein said support member is capable of being moved up and down via an elastic member disposed therebetween.

2. The docking device of claim 1, wherein said casing is configured to receive a portable computer, and the docking device is connected to said portable computer via said connector for extending functions of said portable computer.

3. The docking device of claim 3, wherein when said docking device is connected to said portable computer via said connector, said docking device supports said portable computer by causing a bottom surface of said portable computer to be urged by said support member.

4. The docking device of claim 3, wherein when said docking device is not connected to said portable computer, said support member is arranged so that an upper surface of said support member is positioned to be above an upper surface of said connector.

5. The docking device of claim 1, wherein said docking device is provided with a lock mechanism that restricts movement of said support member.

6. The docking device of claim 1, wherein said lock mechanism is released when a convex positioning portion is inserted into a concave portion.

7. The docking device of claim 6, wherein said convex positioning portion is provided on said support member so as to be inserted into said concave portion that is formed on a bottom surface of said portable computer.
